(19) United States
(12) Patent Application Publication
(10) Pub. No.: US 2016/0089756 A1
(43) Pub. Date: Mar. 31, 2016

(54) TOOL CLAMPING SYSTEM

(71) Applicant: BILZ WERKZEUGFABRIK GMBH & CO. KG, Ostfildern (DE)

(72) Inventor: Juergen FRONIUS, WALHEIM (DE)

(21) Appl. No.: 14/959,340

(22) Filed: Dec. 4, 2015

Related U.S. Application Data
(63) Continuation of application No. PCT/EP2014/058061, filed on Apr. 22, 2014.

(30) Foreign Application Priority Data
Jun. 6, 2013 (DE) 10 2013 105 830.2

(51) Int. Cl. B23Q 5/04; B23B 27/16; B23Q 1/00; B23B 31/02

(52) U.S. Cl. CPC B23Q 5/043; B23B 31/02; B23B 27/16; B23Q 1/0009; B23B 2205/12; B23B 2250/12; B23B 2270/022

(57) ABSTRACT

A tool clamping system is disclosed having a tool holder for clamping a cutting tool, wherein a device including at least one Seebeck element for generating a voltage from thermal energy of the tool clamping system is provided.

### CROSS-REFERENCES TO RELATED APPLICATIONS

This application is a continuation of international patent application PCT/EP2014/058061, filed on Apr. 22, 2014 designating the U.S., which international patent application has been published in German language and claims priority from German patent application 10 2013 105 830.2, filed on Jun. 6, 2013. The entire contents of these applications are incorporated herein by reference.

### BACKGROUND OF THE INVENTION

The invention relates to a tool clamping system having a rotationally drivable tool holder for clamping a cutting tool.

Tool clamping systems of this type have been known for decades and are used in many ways when machining workpieces.

For some years, it has been required in some machining centers with rotating tools, in addition to the conventional cutting tools, to also provide for measurement-based applications or monitoring operations of the cutting or machining tool. These are generally applications in which a measurement system, usually based on electromechanical principles, is mounted on a spindle interface. On the one hand the connection and guidance is to be ensured by the machine kinematics, and on the other hand the sensing of the measured values and transfer thereof to the controller are to be made possible. Here, the energy supply of the measurement system must be provided usually by batteries or accumulators. The data transfer to a fixed evaluation station takes place as standard via infrared transmitters and receivers, and increasingly also via radio.

However, the supply by means of battery or accumulator is usually a limiting variable, since the assurance of the energy supply thus leads to additional maintenance and supervision effort. The charging station is normally located outside the machine tool, or the application in question must be removed from the machine tool in order to change the battery. In addition, the energy supply in the case of sensor systems or possibly also actively operating, actuator systems generally constitutes a limitation. As a result, and due to the extremely harsh environment in the working area of machine tools, the equipping of tools known per se with additional intelligence is not successful in principle.

In view of this, there is a need for tool monitoring systems that can operate with machine tools without external energy supply.

### SUMMARY OF THE INVENTION

It is a first object of the invention to disclose a tool clamping system having a tool holder for clamping a cutting tool, which system allows an energy supply for generating electrical energy without an external voltage supply in the form of a battery or an accumulator.

It is a second object of the invention to disclose a tool clamping system allowing to monitor at least one operating parameter of the tool clamping system.

It is a third object of the invention to disclose a tool clamping system allowing to transmit a signal from a cutting tool wirelessly to an external receiver.

According to one aspect of the invention these and other objects are solved by a tool clamping system comprising:
a tool holder for clamping a cutting tool; and
at least one Seebeck element arranged on said cutting tool for generating a voltage from thermal energy of said tool clamping system.

The object of the invention is fully achieved in this way.

In accordance with the invention thermal energy provided in any case with the tool clamping system is used to generate electrical energy therefrom. The thermal energy may result from the heating of the tool in the region of the cutting edge(s) by the cutting process during use.

In accordance with an advantageous embodiment of the invention the device has at least one Seebeck element for generating a voltage from thermal energy of the tool clamping system.

With Seebeck elements temperature differences can be converted directly into electrical energy. The thermal energy released by the machining as a result of the heating of the cutting edge(s) can thus be converted directly into electrical energy.

In an advantageous development of this embodiment the at least one Seebeck element is arranged in the tool in a region between a cutting edge or a cutting edge support and a cooling channel of the tool.

The maximum temperature difference between the hot cutting edge and the cooling channel is typically provided in this region. A maximum yield in the case of the voltage generation is thus provided.

In accordance with a further embodiment of the invention the at least one Seebeck element is arranged in the region of the cutting edge support, preferably in contact with a cutting edge plate.

In this way, the thermal energy produced in particular at the cutting edge or the cutting edge plate as a result of the heating can be utilized particularly advantageously.

In an advantageous development of the invention the at least one

Seebeck element is applied resiliently against the cutting edge or the cutting edge plate.

Particularly good contact can be produced in this way.

In an additional development of the invention the at least one Seebeck element is fastened by means of thermal contact gel.

In this way, it is possible to compensate for unevennesses on the contact face between the Seebeck element and the cutting plate, such that an optimal heat transfer is enabled.

In a further advantageous embodiment of the invention a plurality of Seebeck elements are provided, which are preferably connected to one another in parallel.

In this way, the energy yield can be improved; as a result of a temperature monitoring at different locations, a process monitoring can additionally take place at the same time.

In a further advantageous embodiment of the invention the Seebeck elements connected in parallel are coupled to one another via threshold switches and are preferably short-circuited in each case via high resistances.

Provided the individual Seebeck elements deliver different output voltages, internal losses are prevented by the threshold switches. Below the threshold value, the voltage of the respective Seebeck element is short-circuited via a high resistance.

A robust voltage supply can be provided in this way.

The high resistances are in any case greater than the resistance of a consumer supplied by the circuit. Since, if the temperature gradient reverses, there is a polarity reversal in the case of a Seebeck element, the output voltage of a plurality of Seebeck elements connected in parallel, which are preferably coupled to one another via threshold switches, is fed to a rectifier, preferably a bridge rectifier, in accordance with a further advantageous embodiment of the invention.

In this way, an optimal voltage yield is ensured and internal compensating currents are avoided.

In accordance with a further embodiment of the invention the output voltage of the least one Seebeck element is fed to a device for voltage stabilization, which preferably has at least one Zener diode and/or a capacitor.

A stable voltage supply can be obtained with an embodiment of this type.

In accordance with a further embodiment of the invention the output voltage of the Seebeck elements is fed to a differential amplifier or comparator.

In this way, the Seebeck elements themselves can be used as sensor for monitoring an operating parameter, since conclusions can be made regarding the state of the overall system on the basis of the output voltage of the Seebeck elements.

If, for example in the case of a drill having two cutting edges, two Seebeck elements are received symmetrically, it is assumed in the normal state that both Seebeck elements deliver the same compensating voltage. If the differential amplifier thus generates an output voltage of approximately 0, it is to be assumed that the process is in equilibrium. This means that both cutting edges are intact and that the associated cooling channels are functioning correctly.

If, however, an output voltage that is different from 0 is generated, either one of the two cutting edges is worn or the associated cooling channel is blocked. Here, depending on the polarity of the output voltage, either the cutting edge 1 or the cooling channel 1 is affected, or the cutting edge 2 or the cooling channel 2 is affected.

In this way, low-loss monitoring can be performed during operation using particularly simple means. Such information is helpful, particularly in the implementation of minimal lubrication (ML) of tools having a plurality of cutting edges, in order to ensure uniform wetting of all cutting edges.

In accordance with a further embodiment of the invention the output voltage of the at least one Seebeck element is fed to a consumer in the form of a sensor and/or a transmitter for the wireless transfer of a useful signal to a stationary evaluation circuit.

The voltage generated by the at least one Seebeck element may preferably be used, following suitable stabilization and smoothing, for the wireless transfer of a useful signal to a stationary evaluation circuit. Here, the transfer may be performed for example via radio, via RFID, or via WIFI, etc. On the one hand the output voltages of different Seebeck elements can be used themselves as a useful signal for monitoring an operating parameter. On the other hand, one or more sensors can be operated with the aid of the generated voltage, said sensors being used for the monitoring of certain operating parameters.

Here, the operating parameter may be, for example, the temperature of the tool, the temperature of the coolant, the cutting force, or acceleration or cutting integrity of the tool. If a separate sensor is used, this is preferably received in the tool and is supplied with voltage by the at least one Seebeck element. The output signal is preferably transferred wirelessly to a stationary evaluation circuit by means of a transmitting device.

Since the space in the tool itself is extremely limited, the tool in accordance with a further embodiment of the invention is to be coupled to the tool holder via an electric interface for the transfer of an electric signal.

In this way, merely the at least one Seebeck element for example may be arranged in the tool, whereas all further elements are provided in the tool holder. For example, a transmitting device for the wireless transfer of a signal may thus be provided.

If a sensor is to be provided with voltage by the at least one Seebeck element, it is expedient to integrate this Seebeck element in the tool in order to enable the most sensitive possible parameter detection.

Depending on dimensions and installation conditions, however, it may be necessary to also provide the sensor in the tool holder.

It is also conceivable to accommodate the Seebeck element also in a pocket in the cutting edge (indexable insert) itself, said pocket being formed by sintering or by means of other suitable methods.

In this case the cutting edge and the Seebeck element form a unit, and only the thermal contact with the cooling channels or the other available temperature pole is also provided in the cutting edge support.

In accordance with a further embodiment of the invention the output signal of the at least one piezo element is fed back to a controller of the drive machine as control variable.

The fed-back signal may be used advantageously for process adaptation.

It goes without saying that the features mentioned above and the features yet to be explained hereinafter can be used not only in the specified combinations, but also in other combinations or independently, without departing from the scope of the invention.

### BRIEF DESCRIPTION OF THE DRAWINGS

Further features and advantages of the invention will emerge from the following description of preferred exemplary embodiments with reference to the drawing, in which:

FIG. 1 shows a simplified view of a tool clamping system according to the invention on the basis of the example of a short-hole drill;

FIG. 2 shows a view of the tool clamping system according to FIG. 1;

FIG. 3 shows a view of an indexable insert, which is received on a cutting support, wherein installation positions for a Seebeck element are indicated;

FIG. 4 shows a section through a cutting edge support with indexable insert securely screwed thereto, wherein a Seebeck element is received resiliently below the indexable insert;

FIG. 5 shows a simplified schematic illustration of a tool clamping system in which an electric interface is indicated between the end of a shaft of the tool and the tool mount, and

FIG. 6 shows an exemplary circuit with two Seebeck elements, which are connected to one another in parallel and are coupled via threshold switches, with downstream rectifier and voltage stabilizer and differential amplifier for comparison of the output voltages of the Seebeck elements, and additionally also with an optional additional sensor and an optional transmitting unit.

### DESCRIPTION OF PREFERRED EMBODIMENTS

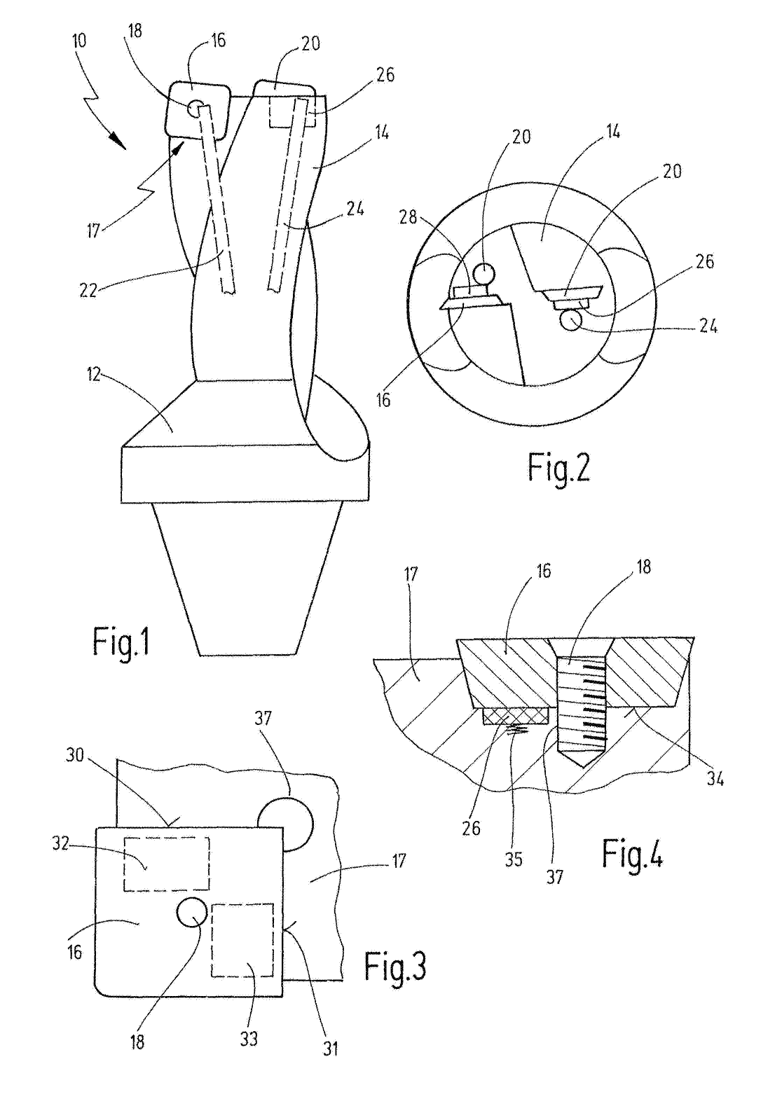

An exemplary embodiment of a tool clamping system according to the invention is illustrated in FIG. 1. This is a short-hole drill having two cutting edges in the form of indexable inserts.

The tool clamping system 10 has a tool holder 12, on which a tool 14 is received in the form of the short-hole drill. As can be seen in particular also from the view according to FIG. 2, two cutting edges 16, 20 are received at the outer end of the tool 14 and are formed on indexable inserts.

As is usual in the case of short-hole drills, the two cutting edges 16, 20 are received slightly asymmetrically offset radially with respect to the longitudinal center axis. The cutting edges 16, 20 or indexable inserts are fastened to the associated cutting edge supports 17 in the conventional manner using fastening screws 18. Each cutting edge support 17 is assigned a cooling channel, wherein the two cooling channels are indicated in FIG. 1 schematically in a dashed manner in the outer region by 22 and 24.

A Seebeck element 26, 28 is arranged between each cutting support 17 and the assigned cooling channel 22, 24 (FIG. 2).

The Seebeck elements 26, 28 are thus each located in the region of the maximum temperature difference, such that a maximum energy yield is achieved.

A position of installation for the Seebeck element is sketched by way of example in FIG. 3. An indentation is provided, in a manner known in principle, on the cutting edge support 17, the cutting edge 16 in the form of the indexable insert being held at said indentation and fastened thereto using a fastening screw 18. Here, paired bearing edges 30, 31 serve to provide support in the force-absorbing region. In the corner region, a recess 37 may be provided between the two bearing edges 30, 31 in order to avoid a loading of the corner of the indexable insert. At the lower base of the indentation in the cutting edge support 17, the Seebeck element in question may preferably be arranged in contact with the indexable insert received thereabove, as indicated by way of example by the dashed positions 32 and 33. The position of installation is provided here in such a way that the Seebeck element is not located directly in the maximally loaded force-absorbing region.

FIG. 4 illustrates in section, by way of example, how the Seebeck element 26 can be installed below the lower support face 34 for the indexable insert 16. Here, in order to press against the indexable insert 16, a spring element 35 can additionally be provided, and thermal contact gel can additionally be used in order to improve the thermal contact.

In FIG. 4 the position of installation for the indexable insert 16 is sketched merely schematically together with the associated fastenings screw 18. In practice, the threaded portion 37 in the cutting edge support 17 is laterally offset against the load direction with respect to the normal position of installation of the fastening screw 18 in order to enable a better force take-up. This illustration has been omitted here for reasons of simplification.

It is also conceivable to accommodate the Seebeck element 26 also in a pocket in the cutting edge (indexable insert) itself, said pocket being formed by sintering or by means of other suitable methods, wherein the cutting edge and Seebeck element 26 then form a unit and only the thermal contact with the cooling channels or the other available temperature pole is also provided in the indexable insert mount 34.

FIG. 5 schematically indicates how, in the case of a tool clamping system, the output signal of the least one Seebeck element 26 can be transferred to the tool holder 12 via an electric interface.

In the case of the tool clamping system designated on the whole by 10a, corresponding reference numerals are used incidentally for corresponding parts. In the outer region of the tool 14 a Seebeck element 26 is indicated schematically in the region of a cutting edge. The tool 14 is clamped via its shaft 36 in an associated recess of the tool holder 12, for example by shrink clamping or in the usual manner by mechanical clamping. An electric interface designated on the whole by 40 is provided at the lower end of the tool shaft 36, via which interface the signal transferred via a line 38 from the Seebeck element 26 is transferred via a contact face 41 with the aid of a contact pin 42 applied thereto to the tool holder 12. The contact face 41 on the tool shaft 36 is electrically insulated with respect to the rest of the tool shaft 36 by means of suitable ceramic faces. The contact pin 42 is likewise received in the tool holder 12 in an electrically insulated manner and is preferably applied resiliently against the contact face 41 by means of a spring element 44 in order to ensure the most secure and reliable contact possible. The signal received by the contact pin 22 is transferred via a line, which is indicated schematically by 46, to a transmitting unit in the tool holder 12, in which the signal is processed and transferred by radio to an associated stationary evaluation circuit 50. It goes without saying that the transmitting unit 48 is provided with a suitable antenna such that the signal can be received and evaluated by a stationary evaluation circuit 50 via an associated antenna 51.

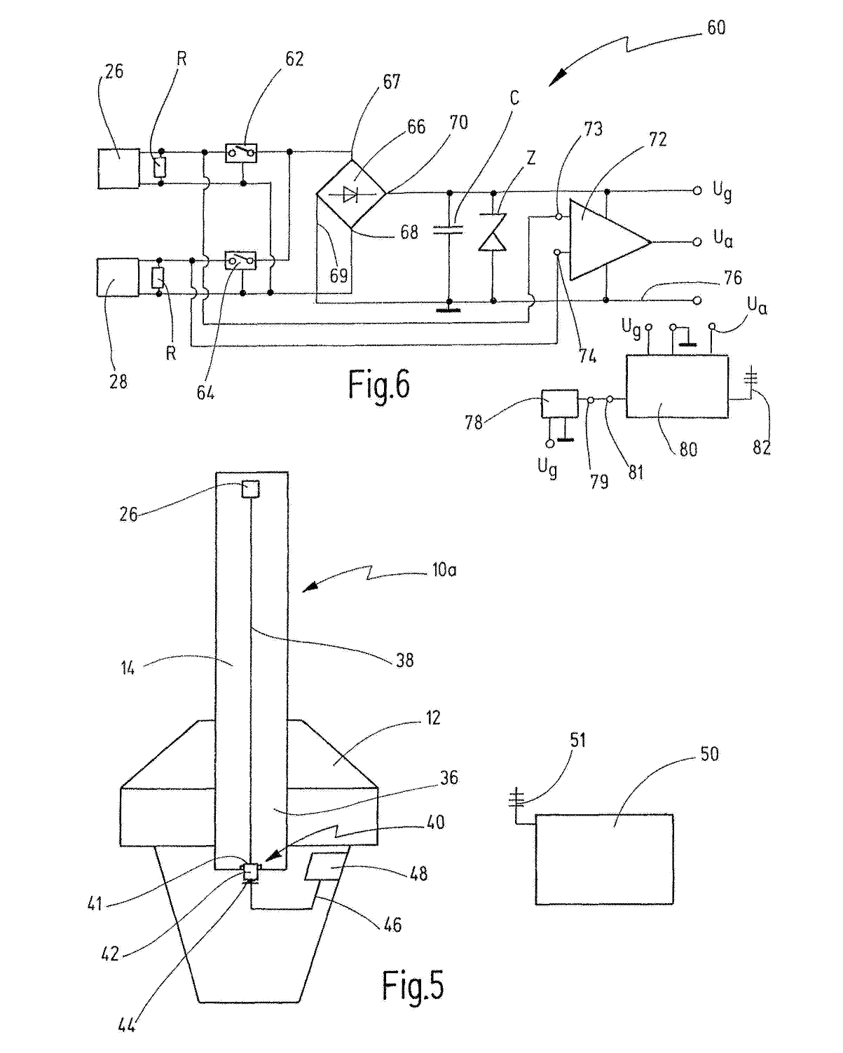

In FIG. 6 a circuit 60 is illustrated by way of example which is provided for monitoring a tool by means of two Seebeck elements 26, 28. Both Seebeck elements 26, 28 are connected to one another in parallel via threshold switches 62, 64, which then only open when the Seebeck element in question exceeds a certain minimum voltage. The output voltage output by the two threshold switches 62, 64 with interconnection is provided at the two inputs 67, 68 of a bridge rectifier 66. The two outputs of the bridge rectifier 69, 70 serve to generate a stabilized DC voltage and to supply a differential amplifier 72. A capacitor C and a Zener diode Z are provided for voltage stabilization. One output 69 is connected to ground 76 together with the capacitor C and the Zener diode Z and the differential amplifier 72. The other output 70 of the bridge rectifier 66 delivers the total output voltage U_{g} and serves, inter alia, for the supply of the differential amplifier 72.

The two output signals of the first Seebeck element 26 and of the second Seebeck element 28 are provided at the two inputs of the differential amplifier 73 and 74.

In addition, the two Seebeck elements 26, 28 are loaded by a high resistance R, which allows a voltage breakdown when the respective threshold switches 62, 64 are not interconnected. This resistance R has a sufficiently high impedance, i.e. is in any case much greater than the resistance of a load by which the useful voltage U_{g} is loaded.

If a voltage Uₐ of approximately 0 is produced at the output of the differential amplifier, both Seebeck elements 26, 28 thus deliver the same output voltage.

With symmetrical installation and otherwise identical conditions, this shows that the paired cutting edges 16, 20 must be intact and that the associated cooling channels 22, 24 function consistently.

If, however, an output voltage Uₐ that is different from 0 is produced, this is due to the fact that either one of the two cutting edges 16, 20 is worn unevenly or that one of the two cooling channels 22, 24 is blocked.

Depending on whether the output voltage Uₐ is greater than 0 or less than 0, either one cutting edge 16 or the other cutting edge 20 or the associated cooling channel 22 or 24 respectively is affected.

An associated evaluation and transmitting unit 23 is additionally also illustrated in FIG. 6 with numeral 80 and, by means of an antenna 82, enables a wireless transfer of a useful signal to a stationary evaluation unit. The entire useful voltage U_{g} serves for voltage supply, whereas the output voltage Uₐ of the differential amplifier 72 can be used as input. The high-frequency signal is transferred to a stationary evaluation unit via an antenna 82. The stationary evaluation unit may also be integrated in a central machine controller, by which the extracted signal is used to adapt the operating process.

By way of example, a further sensor is also indicated by numeral 78, which sensor is operated with the voltage U_{g} and of which the output signal 79 can be coupled to an associated input 81 of the evaluation and transmitting unit 80. Other operating parameters can be monitored using a sensor 78 of this type.

1. A tool clamping system comprising:
a tool holder for clamping a cutting tool;
a cutting edge support arranged on said tool;
a cutting edge plate held on said cutting edge support; and
at least one Seebeck element arranged on said cutting tool in close vicinity to said cutting edge support for generating a voltage from thermal energy of said tool clamping system.

2. The tool clamping system of claim 1, wherein said at least one Seebeck element is arranged in contact with said cutting edge plate.

3. A tool clamping system comprising:
a tool holder for clamping a cutting tool; and
at least one Seebeck element arranged on said cutting tool for generating a voltage from thermal energy of said tool clamping system.

4. The tool clamping system of claim 3, wherein said at least one Seebeck element is held resiliently against said cutting edge or a cutting edge plate supported on said cutting edge.

5. The tool clamping system of claim 3, wherein said at least one Seebeck element is fastened by means of thermal contact gel.

6. The tool clamping system of claim 3, further comprising a plurality of Seebeck elements.

7. The tool clamping system of claim 6, said plurality of Seebeck elements are connected to one another in parallel.

8. The tool clamping system of claim 6, wherein said Seebeck elements are coupled to one another via threshold switches.

9. The tool clamping system of claim 6, wherein each of said Seebeck elements is short-circuited via a high resistance.

10. The tool camping system of claim 6, wherein an output voltage of said plurality of Seebeck elements is fed to a rectifier.

11. The tool clamping system of claim 10, wherein an output side of said rectifier is fed to a voltage stabilizer.

12. The tool clamping system of claim 6, wherein an output voltage of said Seebeck elements is fed to a differential amplifier or comparator.

13. The tool clamping system of claim 3, wherein an output voltage of said at least one Seebeck element is fed to a transmitter for wireless transfer of a useful signal to a stationary evaluation circuit.

14. A tool clamping system comprising:
a tool holder for clamping a cutting tool; and
at least one Seebeck element arranged on said cutting tool for generating a voltage from thermal energy of said tool clamping system, wherein an output voltage of said at least one Seebeck element is used as sensor signal for monitoring an operating parameter of said tool clamping system.

15. The tool clamping system of claim 3, wherein a sensor is received on said cutting tool, said sensor being powered with voltage output by said at least one Seebeck element, said sensor generating an output signal being transferred to a stationary evaluation circuit by means of a transmitting device in order to monitor an operating parameter of said tool clamping system.

16. The tool clamping system of claim 3, further comprising an electric interface for transferring an electric signal from said cutting tool to said tool holder.

17. The tool clamping system of claim 3, wherein comprising a transmitter arranged on said tool holder for wireless transfer of a signal form said cutting tool to an external receiver.

18. The tool clamping system of claim 3, wherein said cutting tool is configured as a cutting tool selected from the group consisting of a drilling tool, a milling tool, and a sawing tool.

19. The tool clamping system of claim 3, wherein said cutting tool comprises a cooling channel, and wherein said at least one Seebeck element is arranged on said cutting tool in a region between said cooling channel and said cutting edge or a cutting edge support.

20. The tool clamping system of claim 3, further comprising a pocket provided on said cutting edge or on an indexable insert, and wherein said at least one Seebeck element is integrated within said pocket.
